(19) United States
(12) Patent Application Publication
(10) Pub. No.: US 2007/0014101 A1
(43) Pub. Date: Jan. 18, 2007

(54) Auxiliary lamp for wrench

(75) Inventor: Tony Huang, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: HIEVER CO. LTD., Taichung City (TW)

(21) Appl. No.: 11/182,888

(22) Filed: Jul. 18, 2005

(51) Int. Cl. B25B 23/18

(52) U.S. Cl. 362/119

(57) ABSTRACT

An auxiliary lamp, which is adapted to be mounted on a wrench, includes a clipping device and an illuminating device. The clipping device has a plate member and a first joint portion on the plate member. The plate member has two clipping portions, between which is a clipping space to receive the hand tool therein, and a tightening member on an interior side of the clipping portion to tighten the hand tool. The illuminating device has a housing, a lamp on the housing, a battery chamber in the housing to receive battery therein and a second joint portion on the housing. The second joint portion of the illuminating device is pivotally connected to the first joint portion of the clipping device such that the illuminating device is pivoted on the clipping device.

### BACKGROUND OF THE INVENTION

1. Field of the Invention

The present invention relates generally to an illuminating device, and more particularly to an auxiliary lamp for a wrench.

2. Description of the Related Art

Works need higher illumination on work place for precise task. In some work places, such as in the engine room or in a machine, light cannot reach the very place. Especially when worker operates a wrench to turn a nut or bolt in a narrow space, light is barred by hand and the wrench, such that worker usually engages the wrench with the nut by feeling. Usually it takes worker longer time to finish the task.

### SUMMARY OF THE INVENTION

The primary objective of the present invention is to provide an auxiliary lamp for a wrench, which illuminates the place where the nut or bolt is.

According to the objective of the present invention, an auxiliary lamp, which is adapted to be mounted on a hand tool, includes a clipping device and an illuminating device. The clipping device has a plate member and a first joint portion on the plate member. The plate member has two clipping portions, between which is a clipping space to receive the hand tool therein, and a tightening member on an interior side of the clipping portion to tighten the hand tool. The illuminating device has a housing, a lamp on the housing, a battery chamber in the housing to receive at least a battery therein and a second joint portion on the housing. The second joint portion of the illuminating device is pivotally connected to the first joint portion of the clipping device such that the illuminating device is pivoted on the clipping device.

### BRIEF DESCRIPTION OF THE DRAWINGS

FIG. 1 and FIG. 2 are exploded views of a first preferred embodiment of the present invention;

FIG. 3 shows the lamp of first preferred embodiment of the present invention mounted on a socket wrench;

FIG. 4 and FIG. 5 are exploded views of a second preferred embodiment of the present invention, and

FIG. 6 shows the lamp of first preferred embodiment of the present invention mounted on a socket wrench.

### DETAILED DESCRIPTION OF THE INVENTION

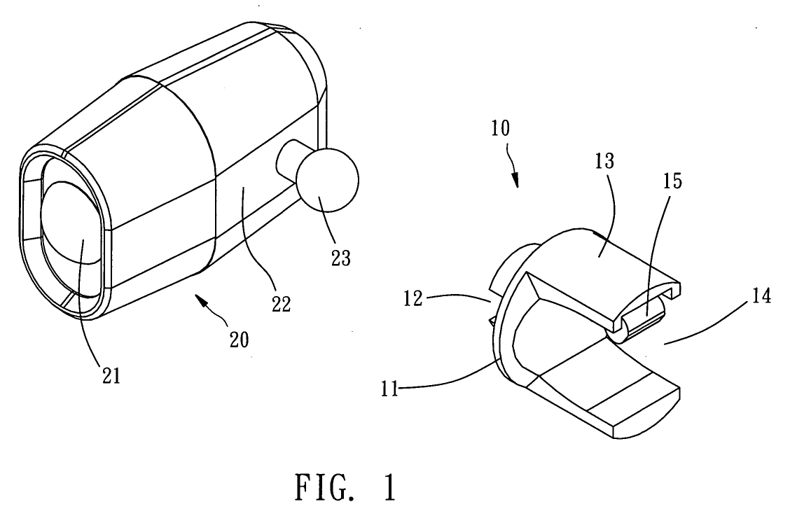

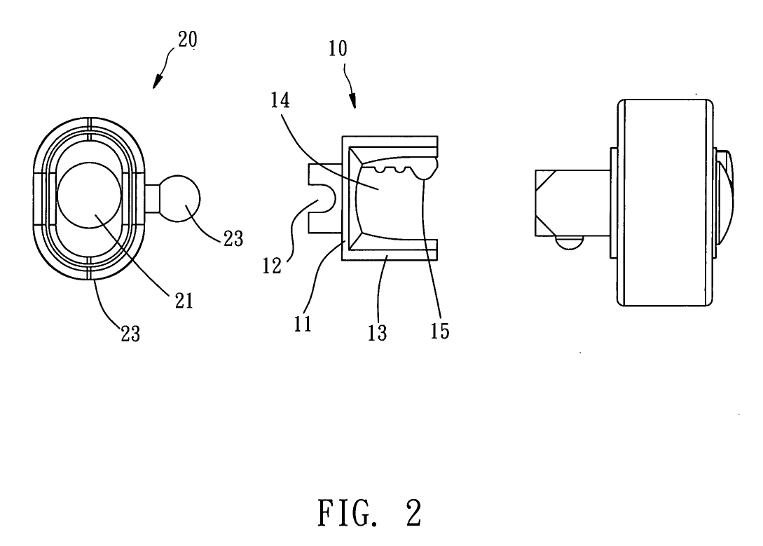

As shown in FIGS. 1 to 2, an auxiliary lamp for a wrench of the first preferred embodiment of the present invention comprises:

A clipping device 10 has a plate member 11, a first joint portion 12 on a back of the plate member 11, two clipping portions 13 on the plate member 11, between which a clipping space 14 is formed, and a tightening member 15 on an interior side of the clipping portion 13. The tightening member 15 may be an elastic member, such as spring, rubber, plastic or a C-shaped spring plate to hold a handle of the wrench in the clipping space 14. In the present embodiment, the tightening member 15 is a rubber block with protrusions mounted on the clipping portion 13, and the first joint portion 12 is a socket.

An illuminating device 20 has a housing, in which a lamp 21 and a battery chamber 22 are provided. The lamp 21 may be a light bulb or a light emitting diode (LED). Batteries (not shown) are received in the battery chamber 22 to provide the lamp 21 power. The housing has a second joint portion 23 on an exterior side thereof, which is a ball joint to be engaged with the first joint portion 12 of the clipping device 10, such that the illuminating device 20 is universally swiveled relative to the clipping device 10.

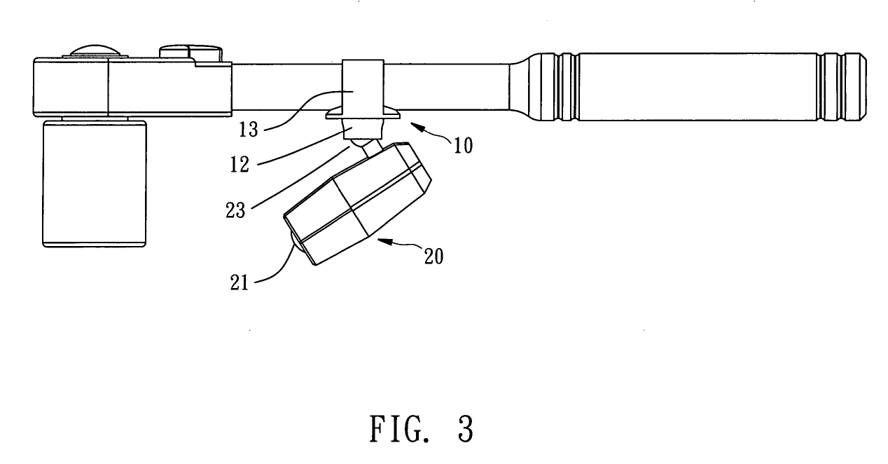

In use, worker clips the clipping device 10 onto the handle of the wrench, seeing FIG. 3, in which the tightening member 15 holds the handle in the clipping space 14 of the clipping device 10 firmly, such that the lamp 21 of the illuminating device 20 can illuminate the desired place without any barrier. In addition, the illuminating device 20 may be turned relative to the clipping device 10, such that works can adjust the place for illumination by turning the illuminating device 20.

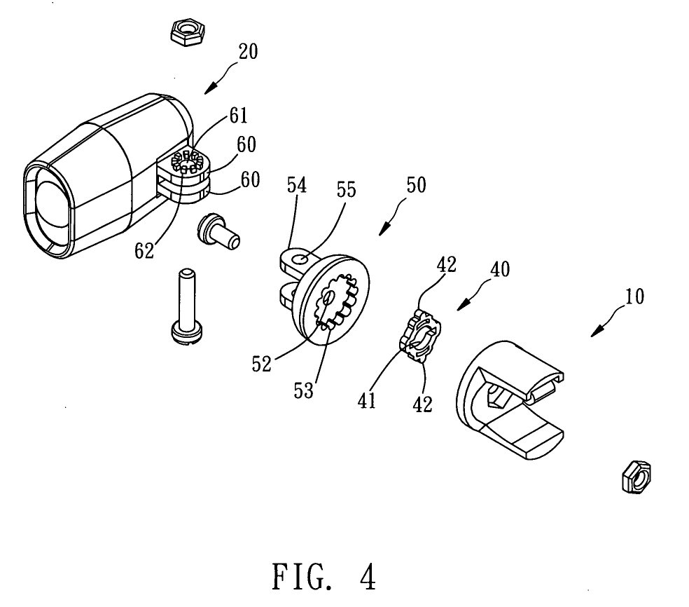

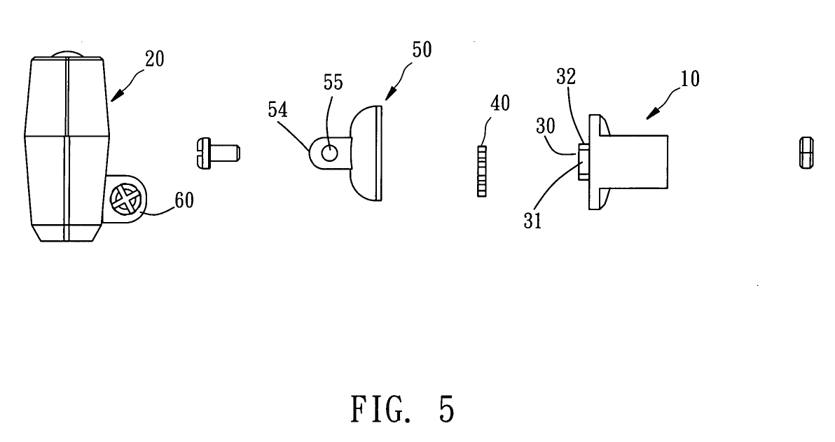

FIGS. 4 and 5 show an auxiliary lamp of a second preferred embodiment, which includes a clipping device 10 and an illuminating device 20. The auxiliary lamp of the second preferred embodiment is similar to the auxiliary lamp of the first preferred embodiment, except that the clipping device 10 has a first joint portion 30, which is a post projected from a plate member thereof. The post 30 has a through hole 31 at a center and two stop portions 32 on an exterior side.

The auxiliary lamp of the second preferred embodiment further includes a pad member 40 with a hole 41 to be fitted to the post 31 of the clipping device 10 and two elastic lock portions on a circumference. An adapter device 50 has a round recess 51 at an end and a hole 52 at a bottom of the recess 51. The adapter device 50 further is provided with teeth 53 on a sidewall of the recess 51. The post 31 is received in the recess 51 for free rotation and lock. The adapter device 50 has two plates 54 projected from an end opposite to the end with the recess 51, each of which has a bore 55.

The auxiliary lamp of the second preferred embodiment has a second joint portion 60, which is two parallel plates with a bore 61 and blocks 62 around the bore 61 respectively, to be inserted into a space between the plates 54 of the adapter device 50 and fixed thereto by a bolt inserted into the bores 55 and 61, such that the illuminating device 20 is pivoted on the adapter device 50. The pad member 40 in the recess 51 of the adapter device 50 provides the second joint portion 60 a friction, such that the illuminating device 20 stops at any position automatically.

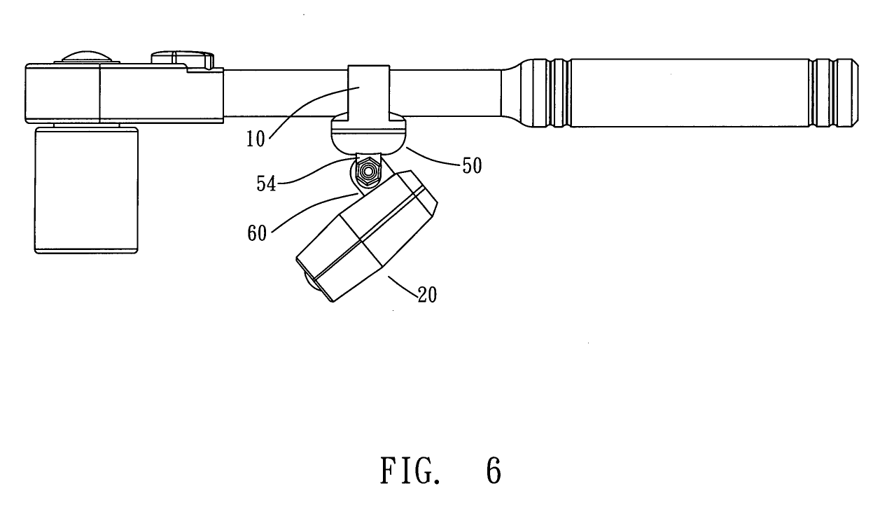

The way of fixing the auxiliary lamp of the second preferred embodiment, seeing FIG. 6, is as same as the auxiliary lamp of the first preferred embodiment, and it functions as same as the auxiliary lamp of the first preferred embodiment also.

What is claimed is:

1. An auxiliary lamp, which is adapted to be mounted on a hand tool, comprising:
A clipping device having a plate member and a first joint portion on the plate member, wherein the plate member has two clipping portions, between which is a clipping space to receive the hand tool therein, and a tightening member on an interior side of the clipping portion to tighten the hand tool, and
an illuminating device having a housing, a lamp on the housing, a battery chamber in the housing to receive at least a battery therein and a second joint portion on the housing;
wherein the second joint portion of the illuminating device is pivotally connected to the first joint portion of the clipping device such that the illuminating device is pivoted on the clipping device.

2. The auxiliary lamp as defined in claim 1, wherein the first joint portion is a ball joint, and the second joint portion is a socket to receive the ball joint.

3. The auxiliary lamp as defined in claim 1, further comprising an adapter device pivoted having opposite ends pivotally connected to the first joint portion and the second joint portion respectively.

4. The auxiliary lamp as defined in claim 3, wherein the adapter device has two plate projected from an end thereof, each of which has a bore.

5. The auxiliary lamp as defined in claim 4, wherein the second jointer portion of the illuminating device has two plates, each of which has a bore.

6. The auxiliary lamp as defined in claim 5, wherein the plates have blocks around the bore respectively.

7. The auxiliary lamp as defined in claim 3, wherein the first joint portion is a post with a through hole and two stop portions, and the adapter device has a recess at an end, a hole at a bottom of the recess and teeth on a sidewall of the recess, and a pad member is received in the recess, which has a hole to be fitted to the post and two elastic lock portions to be meshed with the teeth of the adapter device.
